(19) United States
(12) Patent Application Publication
(10) Pub. No.: US 2006/0249528 A1
(43) Pub. Date: Nov. 9, 2006

(54) Wall mountable dispenser

(76) Inventor: Jonathon P. Myers, Stafford, VA (US)

Correspondence Address: JAMES W. PRAVEL;PRAVEL INTELLECTUAL PROPERTY LAW, PC, 1800 DIAGONAL ROAD, SUITE 600, ALEXANDRIA, VA, 22314, US

(21) Appl. No.: 11/123,034

(22) Filed: May 6, 2005

(51) Int. Cl. B65G 59/00

(52) U.S. Cl. 221/283

(57) ABSTRACT

A wall mountable dispenser for use with consumer wipes includes a hinged top and a first and second support member that releaseably connects to one another. The releasable connection between the support members includes a recess and projection. The overall length of the support member assembly is typically as long as the height of the dispenser top so that the top of a conventional wipes container inserted into the dispenser and the dispenser top will have sufficient clearance to open.

### FIELD OF THE INVENTION

The invention relates to wall mountable dispensers and more specifically to wall mountable dispensers used for consumer wipes.

### BACKGROUND OF THE INVENTION

The consumer wipes market includes not only baby wipes, but also household and personal hygiene wipes. According to market studies, the global market for disposable consumer-oriented wipes is valued at about $4.5 billion and has seen double-digit growth every year since 1997.

A problem that the consumer faces with the proliferation of demand for consumer wipes is the storage and dispensing of the wipes. Typically, the wipes are placed on a counter, in a drawer, on a shelf, or in some other inconvenient or unattractive location.

Existing wall mountable dispensers do not allow clearance for a hinged top to open. Furthermore, existing dispensers do not provide a way to mount the support members releaseably so that one support member may be connected to a wall and another support member may be connected to the dispenser.

### SUMMARY OF THE INVENTION

The invention overcomes the problems described above and includes a wall mountable dispenser that includes a dispenser typically having a hinged top. A first support member may be rigidly and integrally connected to the dispenser. A second support member is connected to a desired wall. A releasable connection is provided between the first and the second support members so that the first support member may be connected to the dispenser and the second support member may be connected to the wall. After the first and second support members are connected to the dispenser and wall; respectively, they are then releaseably connected to each other. By separating the support members, access is provided to connect the connectors to their respective surfaces. If the support were a single member, it would be difficult or impossible to have sufficient access to attach the first support member to the dispenser or the second support member to the wall.

The overall length of the support member assembly may typically be at least as long as a cavity provided in the dispenser top so that the dispenser top has sufficient clearance to open next to the wall on which the wall support is mounted. As a result, access may be provided to the wipes that are contained within a conventional box that is inserted into the dispenser.

A liner may also be provided within the dispenser so that the moisture from the wipes does not corrode the dispenser and it may be removable to simplify the cleaning of the dispenser.

### BRIEF DESCRIPTION OF THE DRAWINGS

FIG. 1 is a front perspective view of an embodiment of the invention showing one of the hexagonal support member assemblies.

FIG. 2 is a rear perspective assembly view of an embodiment of the invention showing two of the hexagonal support member assemblies.

FIG. 3 is a rear perspective assembly view of an embodiment of the invention showing one of the hexagonal support member assemblies.

FIG. 4 is a side sectional view of an embodiment the invention showing a conventional disposable wipes dispenser within the inventive dispenser.

FIG. 5 is a side sectional view of the embodiment of the invention in FIG. 1 showing a disposable wipes inside of the inventive dispenser.

FIG. 6 is a detail view of the dispenser seal assembly shown in FIG. 4.

FIG. 7 is a front perspective view of an embodiment of the invention showing one of the rounded support member assemblies.

FIG. 8 is a front perspective assembly view of an embodiment of the invention showing one of the rounded support member assemblies disassembled.

FIG. 9 is a side sectional view of an embodiment the invention showing a tab and slot connection between support members.

### DETAILED DESCRIPTION OF PREFERRED EMBODIMENT

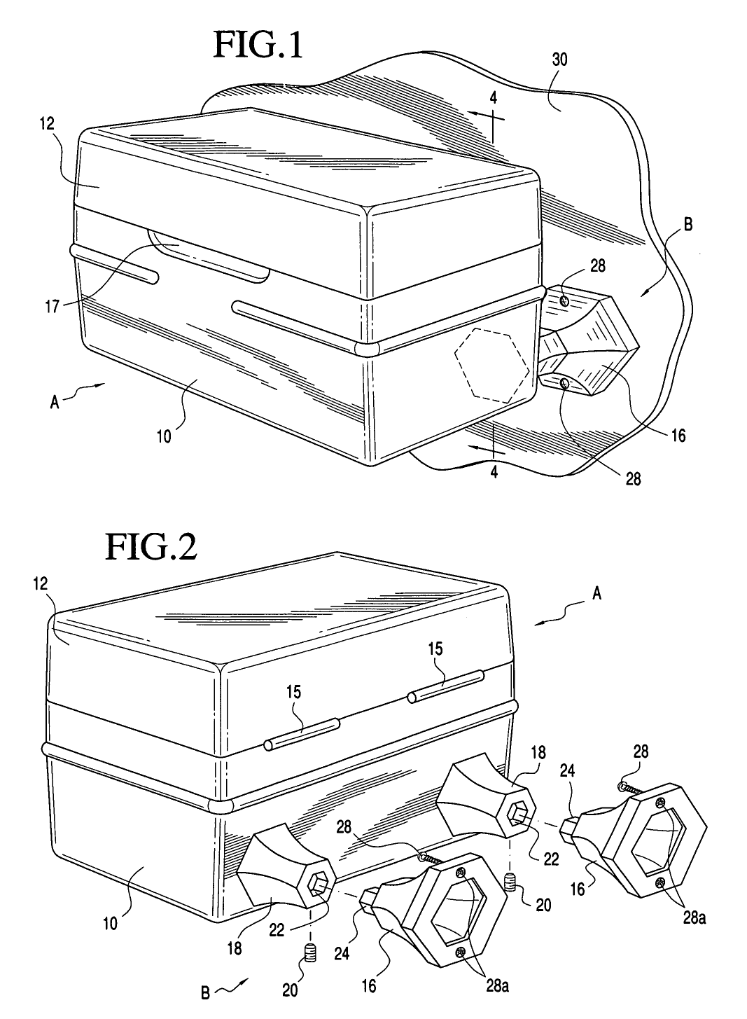

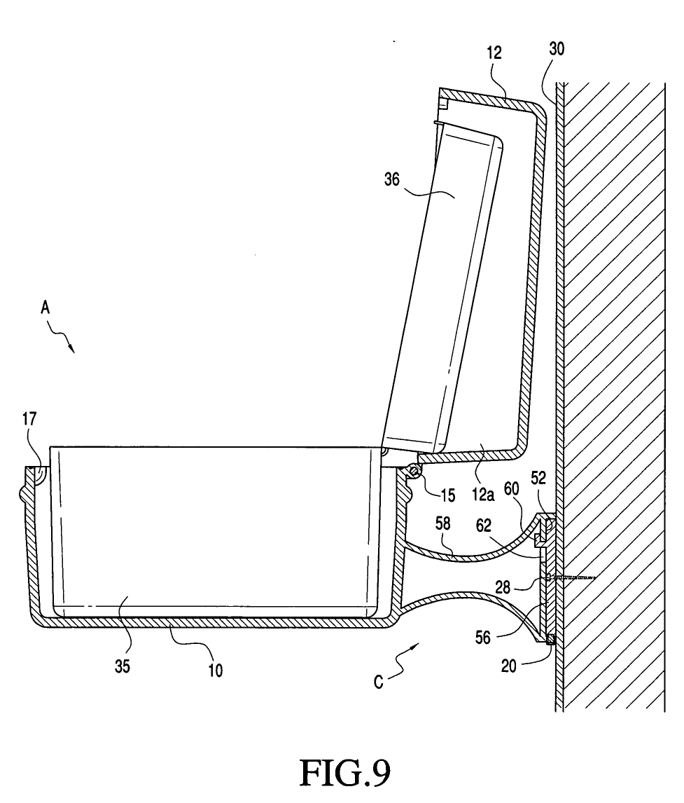

The wall mountable dispenser is generally referred to as A. In FIGS. 1-5, a preferred embodiment of the invention is shown. The dispenser 10 is sized to receive either a conventional wipes dispenser box 35 as shown in FIGS. 4 and 9, or individual wipes 38 as shown in FIG. 5. A dispenser top 12 is typically attached to the dispenser 10 with hinges 15 or other retaining means. A groove 17 is usually provided between the bottom of the dispenser top 12 and is normally integral with the dispenser 10 so that the dispenser top 12 can be lifted upward to access the inside of the dispenser 10 to remove wipes 38. Other opening means may also be provided such as a tab or a handle on the dispenser top 12. An opening or slot may also be provided on the dispenser top 12 to allow access to the wipes without first raising the dispenser top 12.

The dispenser support member 18 is attached to the dispenser 10 in a conventional manner such as bonding, welding or attaching with a nut and bolt or other desired fastener. The dispenser support member 18 may also be molded integrally with the dispenser 10. The recess 22 on dispenser support member 18 is a hexagonal socket, but it may also be configured in alternative shapes such as an oval, circular or multi-sided configuration. The wall support 16 is attached to the wall 30 with one or more screws 28 that extend through screw holes 28a. Expanding bolts or an alternative attachment means may also be used to attach the wall support 16 to the wall 30. The wall support 16 includes a projection 24. The projection 24 is shown as a hexagonal pin, but it too may be configured in alternative shapes that are shaped to insert into the similarly shaped recess 22.

After the projection 24 is inserted into the recess 22, a setscrew 20 is normally screwed into the body of the dispenser support member 18 until it engages the outer surface of the projection 24 of the wall support member 16.

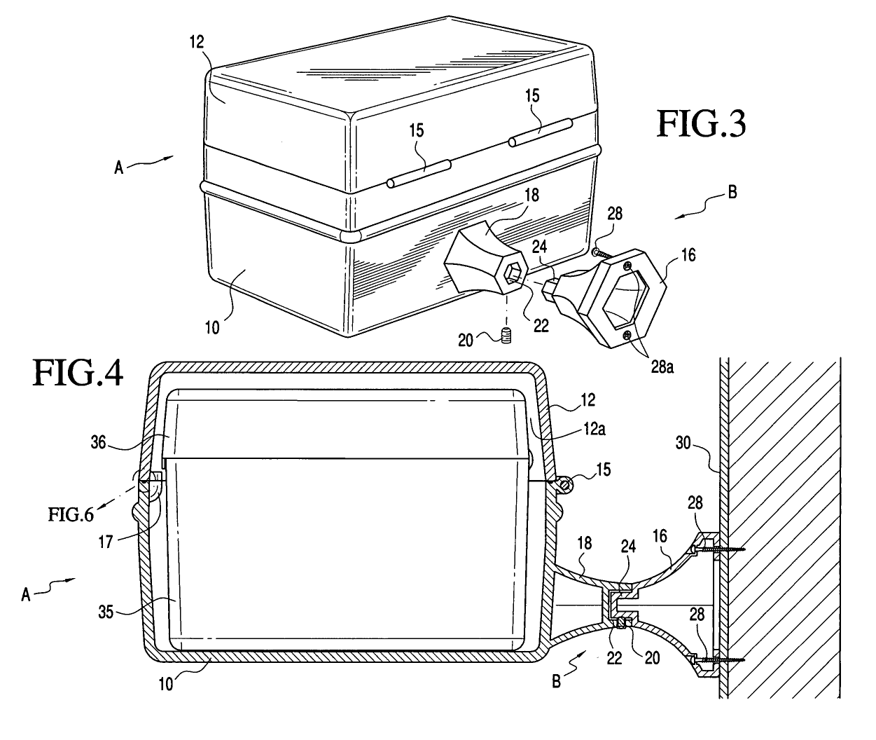

The support assembly B includes the dispenser support 18 and the wall support 16. As shown in FIG. 3, only a single support assembly B is necessary to support the wall mountable dispenser. If a single support assembly B is used, the cross section of the projection 24 and the recess 22 may be non-circular so that there is no rotation of the projection 24 relative to the recess 22 and therefore, the dispenser 10 will remain level. Because the projection 24 on the wall support 16 and the recess 22 on the dispenser support are hexagonal, when the projection 24 is inserted into the recess 22, the dispenser 22 stays stationary and is prevented from rotating.

When a conventional wipes box 35 is inserted into the dispenser 10, it can be important for the dispenser top 12 to include a cavity 12a that is deep enough to allow access to the wipes box top 36, as shown in FIG. 4. As shown in FIG. 9, the overall length of the support assembly B is generally sufficiently long to provide clearance for the dispenser top 12 to open to provide access to the wipes inside the dispenser 10. Once the dispenser top 12 is opened, the wipes box top 36 may then also be opened to gain access to the wipes therein.

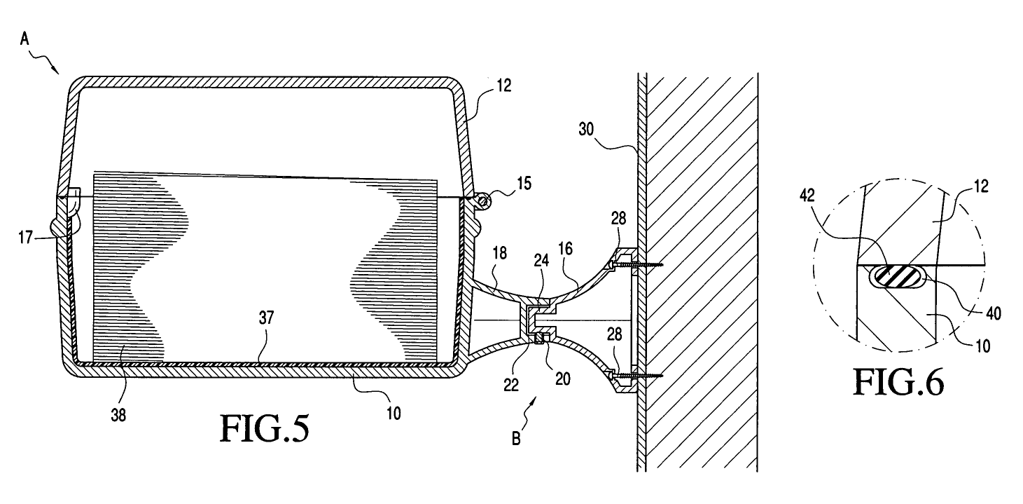

Individual wipes 38 may also be kept inside the dispenser 10 in a stack as shown in FIG. 5. A seal 42 may be provided in a groove 40, as shown in detail in FIG. 6. Because wipes are pre-moistened, the seal 42 can extend the life of individual wipes that are kept in the dispenser 10 and may also further extend the life of wipes that are kept inside the conventional wipes box 35 by preventing evaporation of the moisture in the wipes.

A waterproof liner 37 may be inserted into the dispenser 10 to prevent fluids or other moisture contained in the wipes from contacting the dispenser 10 and to simplify the cleaning of the dispenser 10. The dispenser 10 may be constructed of any desired material, including but not limited to chrome-plated steel, antiqued brass or other metallic material. If a metallic material is used, the liner 37 can help to prevent corrosion from the fluids contained in the wipes. Alternative materials, such as polymers may also be used for the construction of the dispenser 10, dispenser top 12 and support assemblies B or C. Also, a combination of materials may be used, such as metal material for the support assemblies B or C and polymer material for the dispenser 10 and dispenser top 12. Other combinations are also contemplated.

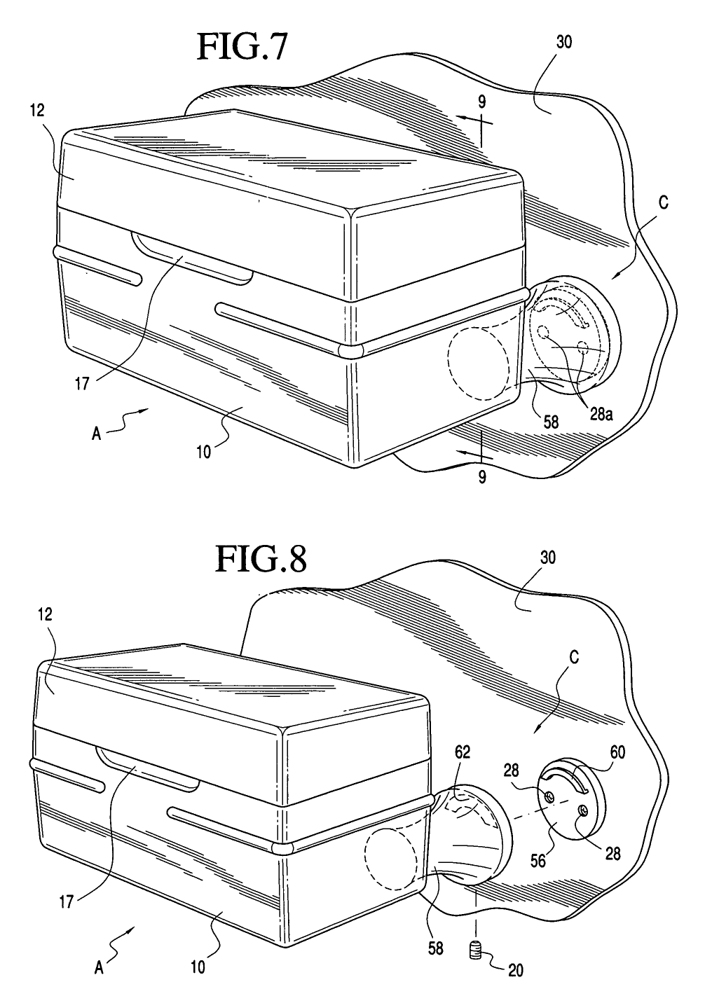

In FIGS. 7-9 an alternative preferred embodiment of the invention is shown. The dispenser support 58 is attached to the dispenser 10 in a conventional manner such as bonding, welding, nut and bolt or otherwise securing method. The dispenser support 58 may also be molded integrally with the dispenser 10. The wall support 56 is attached to the wall 30 with one or more conventional screws 28 or other desired attachment devices such as expanding bolts. A tab 60 is positioned on the wall support 56 that engages a slot 62 in the dispenser support 58. As can be seen in FIG. 9, a recess 52 is provided in the dispenser support 56 so that the dispenser support 58 will cover the wall support 56 and will then fit flush against the wall 30. As shown in FIGS. 8 and 9, a setscrew 20 is threaded into the body of the dispenser support 52 and engages the outside of the wall support 56. When the setscrew 20 is tightened, compressive force is applied between the tab 60 and the slot 62 to mount the dispenser support 58 securely to the wall support 56.

The support assembly C includes the dispenser support 58 and the wall support 52. Only a single support assembly C is necessary to support the wall mountable dispenser, but multiple support assemblies may also be used as shown.

The foregoing disclosure and description of the invention are illustrative and explanatory thereof, and various changes in the details of the illustrated apparatus and construction and method of operation may be made without departing from the spirit of the invention.

What is claimed is:

1. A wall mountable dispenser comprising:
a. A dispenser having a hinged top;
b. A first support member rigidly and integrally connected to said dispenser;
c. A second support member connected to a desired wall;
d. A releasable connection between said first and second support members.

2. A wall mountable dispenser according to claim 1 wherein said releasable connection comprises a recess on one of said support members that is sized to fit a projection on the other of said support members.

3. A wall mountable dispenser according to claim 2 wherein said recess comprises a slot and said projection comprises a tab.

4. A wall mountable dispenser according to claim 2 wherein said recess comprises a bore and said projection comprises a post member.

5. A wall mountable dispenser according to claim 4 wherein said post is secured within said bore with a setscrew.

6. A wall mountable dispenser according to claim 1 wherein said dispenser is constructed of polymer material.

7. A wall mountable dispenser according to claim 1 wherein said dispenser is constructed of metallic material.

8. A wall mountable dispenser according to claim 1 wherein said first and said second support members are constructed of polymer material.

9. A wall mountable dispenser according to claim 1 wherein said first and said second support members are constructed of metallic material.

10. A wall mountable dispenser according to claim 1 comprising a plurality of said first and said second support members.

11. A wall mountable dispenser according to claim 1 wherein said dispenser includes a moisture barrier liner.

12. A wall mountable dispenser according to claim 11 wherein said moisture barrier liner is removable.

13. A wall mountable dispenser according to claim 1 wherein said hinged top includes a cavity to accommodate a raised top on a container contained within said dispenser.

14. A wall mountable dispenser according to claim 13 wherein the overall length of said first and said second support members is longer than the height of said cavity in said hinged top whereby said hinged top can open.

15. A wall mountable dispenser according to claim 2 wherein said recess and said projection are non-circular in cross section.

16. A wall mountable dispenser according to claim wherein a seal is positioned between said dispenser and said top whereby evaporation of the contents of said dispenser is minimized.
